(19) United States
(12) Patent Application Publication
(10) Pub. No.: US 2007/0156425 A1
(43) Pub. Date: Jul. 5, 2007

(54) Using optimization algorithm for quantifying product technical merit to facilitate product selection

(75) Inventors: Richard John Keck, Houston, TX (US); Hauhua Lee, Houston, TX (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/322,366

(22) Filed: Jan. 3, 2006

(51) Int. Cl. G06Q 30/00

(52) U.S. Cl. 705/1

(57) ABSTRACT

A technical merit index tool establishes qualification thresholds to facilitate product selection. The technical merit index tool includes a technical user input section including defined selection factors and desired values for each of the selection factors for a product to be selected. The desired values include a weight factor relating to an importance level for each of the defined selection factors using a first nonlinear optimization algorithm and ranking criteria for each of the defined selection factors using a second nonlinear optimization algorithm. A product supplier input section includes product specifications relating to the defined selection factors. A processor determines a technical merit index for each candidate product based on a summation of normalized product specifications for each of the defined selection factors relative to the desired values. The tool and method facilitate product selection using objective criteria that is weighted based on the importance of the respective selection factors.

### RELATED APPLICATION(S)

This application is related to U.S. application Ser. No. 11/______ (attorney docket 839-1785) and U.S. application Ser. No. 11/______ (attorney docket 839-1790).

### BACKGROUND OF THE INVENTION

The invention relates to facilitating the selection of products such as engineering products and, more particularly, to a system and method that quantify a product technical merit index based on product specifications for defined selection factors relative to desired values.

Selecting components such as pumps, motors, control valves and the like for engineering systems is often a challenging task that requires substantial domain knowledge and experience. In considering products for incorporation into engineering systems, important variables differ among product suppliers, and it has been a challenge to confidently determine which product is best suited for the engineering system. For example, in selecting a hydraulic pump, important selection factors may include outlet pressure, speed, flow ratio, and the like. Available products may satisfy requirements for some of the selection criteria while falling short on others. The engineer is thus faced with the task of determining where to compromise in the desired specifications while selecting a product that would be suitable for the intended application.

### BRIEF DESCRIPTION OF THE INVENTION

In an exemplary embodiment of the invention, a method enables quantifying product technical merit to facilitate product selection. The method includes the steps of (a) identifying selection factors for a product to be selected; (b) establishing a weight factor relating to an importance level for each of the identified selection factors; (c) defining ranking criteria for each of the identified selection factors including at least two levels as high (H) and low (L); (d) determining a technical merit index for each candidate product based on a summation of normalized product specifications for each of the identified selection factors weighted by the respective weight factor and multiplied by the respective ranking criteria; and (e) selecting one of the candidate products based at least partly on a comparison the technical merit index of each candidate product.

In another exemplary embodiment of the invention, a technical merit index tool establishes qualification thresholds to facilitate product selection. The technical merit index tool includes a technical user input section including defined selection factors and desired values for each of the selection factors for a product to be selected, and a product supplier input section including product specifications relating to the defined selection factors. A processor determines a technical merit index for each candidate product based on a summation of normalized product specifications for each of the defined selection factors relative to the desired values.

### BRIEF DESCRIPTION OF THE DRAWINGS

FIG. 1 is an exemplary spreadsheet application of the technical merit index tool of the invention;

FIG. 2 is a flow chart illustrating a usage phase and development phase for the technical merit index tool; and

FIGS. 3-8 are explanatory views to illustrate the use of a constrained non-linear optimization algorithm to determine optimized weight factors and ranking criteria based on field data.

### DETAILED DESCRIPTION OF THE INVENTION

Technical merit index (TMI) focuses on “technical” aspect evaluations in meeting engineering requirements. Examples of technical factors include product performance such as efficiency, internal design/structure, materials of key parts, reliability information like MTBF (mean time between failure) and MTTR (mean time to repair), etc. Non-technical factors such as cost, warranty, terms and conditions, and non-technical personal-preference like color or style, etc. are intentionally left out as they are considered orthogonal to technical factors and should be evaluated in a separate dimension.

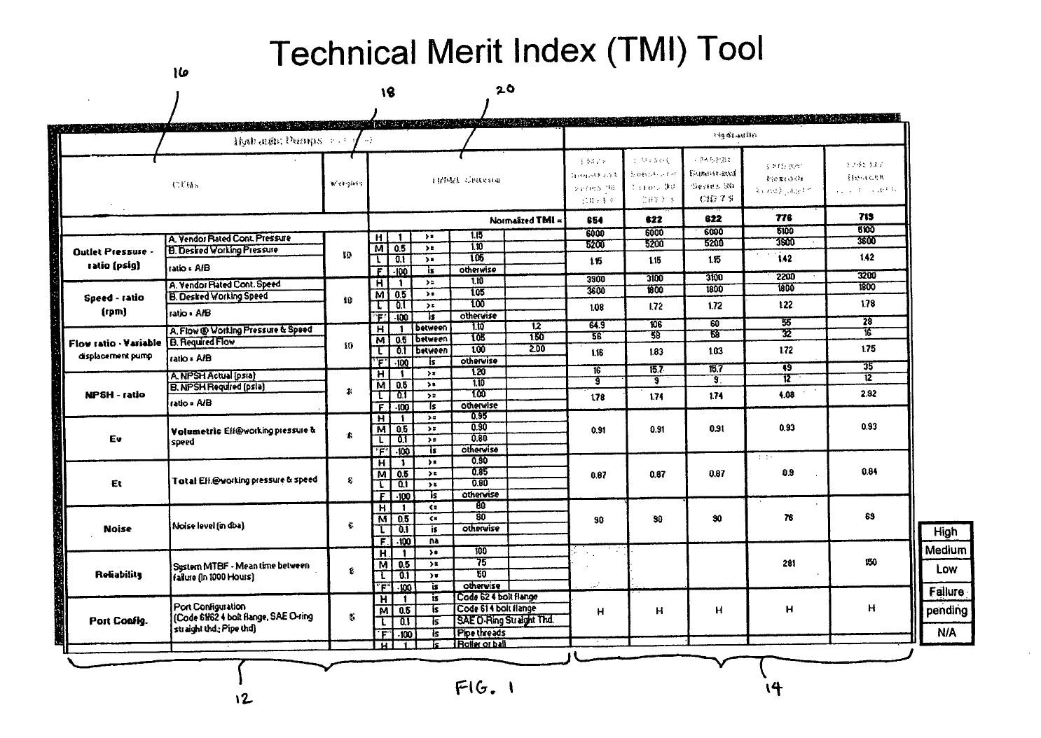

In a preferred application, TMI is defined with respect to specific engineering components and applications, such as pumps used for pumping hydraulic fluid (hydraulic pump), for pumping fuel (fuel pump), for pumping lubrication material (lube pump) or control valves for handling liquid fuel or high pressure water, and the like. FIG. 1 illustrates the TMI tool in a spreadsheet application with reference to an evaluation of hydraulic pumps. Any suitable spreadsheet application may be used, and many such applications are available; thus, details of the use and operation of a spreadsheet application will not be described. An exemplary spreadsheet application suitable for the TMI tool of the invention is an Excel-based application. In such an application, data input into the input cells of the spreadsheet are processed via a processor such as a macro VBA function according to user-input data.

With reference to FIG. 1, the TMI tool includes a technical user input section 12 and a product supplier section 14. The technical user input section 12 includes defined selection factors and desired values for each of the selection factors for a product to be selected. These data are input on the user side by experienced personnel, such as senior engineers or the like for engineering products.

As shown in FIG. 1, the technical user input section 12 lists a plurality of identified critical selection factors 16 for the target component and application. For each of the identified selection factors 16, a weight factor 18 relating to an importance level is established. The weight factors 18 may vary from, for example, 1-10, with 10 being a maximum for an indication that the particular selection factor is of maximum importance in selecting the product.

The technical user input section 12 also includes ranking criteria 20 defined for each of the identified selection factors 16. The ranking factors establish boundaries and tolerances around the desired value for each of the selection factors 16. For example, in the hydraulic pump example illustrated in FIG. 1, a selection factor of maximum importance (indicated by the weight factor 18 listed as ‘10’) is an outlet pressure ratio, which is listed as a ratio of the vendor rated continuous pressure to the desired working pressure. The ranking criteria 20 are divided into high (H), medium (M), low (L) and fail (F), although more or fewer ranking criteria may be utilized. The experienced personnel determine what values of outlet pressure ratio would fall under which ranking criteria. In the example shown in FIG. 1, an outlet pressure ratio greater than or equal to 1.15 is considered high (H), a pressure ratio within the range of [1.1, 1.15] is considered medium (M), an outlet pressure ratio within the range of [1.05, 1.1] is considered low (L), and any outlet pressure ratio less than 1.05 is considered fail (F). The ranking criteria 20 includes a multiplication factor for each ranking, which in the example shown is H=1, M=0.5, L=0.1, and F=−100. These values, of course, could be varied by application or customized for each selection factor 16. In this manner, products having specifications that meet or exceed more important selection factors will be favored in the technical merit index analysis.

The product supplier input section 14 includes product specifications typically provided by the product supplier relating to each of the defined selection factors 16. In the example shown in FIG. 1, there are five hydraulic pump candidates being considered. The selection factor data, such as outlet pressure ratio, is provided by the supplier. With the data input into the spreadsheet, candidate products are evaluated against the predefined ranking criteria 20 for each of the selection factors 16, and the TMI tool obtains TMI scores via a weighted summation of all grades. The raw scores are then normalized to between 0 and 1000, where ‘1000’ represents a perfect score where the candidate is rated ‘H’ for every selection factor 16. A ‘0’ results from the case where at least one of the selection factors 16 is rated ‘F’. If all of the selection factors 16 are rated ‘M’, the score would fall around 500. If all of the selection factors are rated ‘L’, the score would fall around 100.

In analyzing the technical merit index for each of the candidate products, engineering personnel may define a technical qualification threshold as a minimum acceptable technical merit index based on use experience including both success and failure cases and possibly additional statistical analysis such as a linear regression model of the success/failure cases. In the example shown in FIG. 1, assuming a technical qualification threshold was set at TMI=650, two of the candidate products would be immediately disqualified. Subsequently, the remaining candidate products can be evaluated based on engineer experience with a particular product or brand, or other non-technical factors such as cost, etc. discussed above.

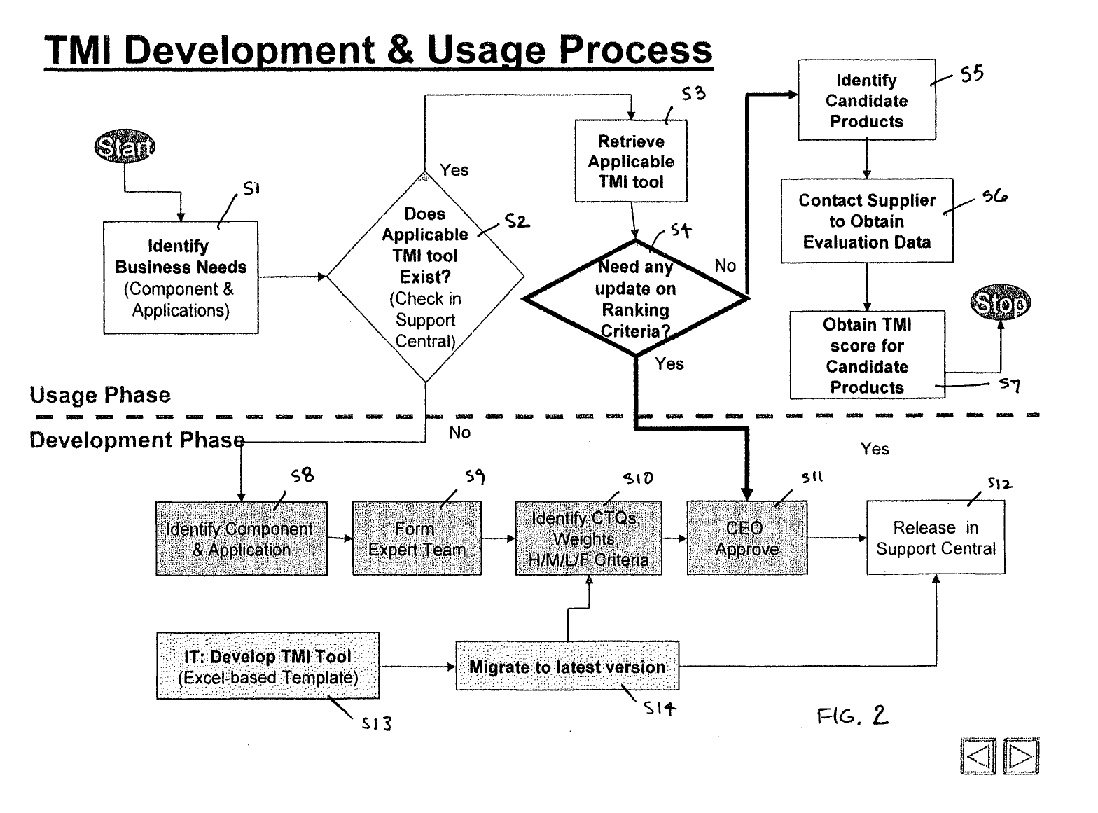

FIG. 2 is a flow chart illustrating a usage phase and development phase of the technical merit index tool. After a business need for a particular component and its application is identified (step S1), a determination is made whether an applicable TMI tool already exists (step S2). If not, the TMI tool for the desired product is developed in a development phase (discussed in more detail below). If so (YES in step S2), the applicable TMI tool is retrieved (step S3), and it is validated whether the selection factors and ranking criteria are all up to date and reflecting the latest technology available (example of such needs is in selecting personal computer, the ranking criteria for CPU and memory should reflect the newest technology) (step S4). If so (YES in step S4), updates are input and appropriate approvals are obtained (step S11), and the updated TMI tool is released for access and use (step S12). If updates are not necessary (NO in step S4), candidate products are identified (step S5). The product supplier input section 14 is then populated with product data from the supplier (step S6). The tool then obtains TMI scores for the candidate products (step S7), and an evaluation and selection of the candidate product can be carried out.

If an applicable TMI tool does not exist (NO in step S2), the TMI tool can be developed in a development phase where the component and application are identified (step S8), and a team of experienced personnel or “expert team” is formed to identify critical selection factors 16, weight factors 18, and ranking criteria 20 (steps S9 and S10). Appropriate approvals are obtained (step S11), and the TMI tool is released for access and use (step S12).

The identification of critical selection factors along with weight factors and ranking criteria is qualitative in nature and requires conversion to numerical data before the TMI computation can be conducted. As discussed above, in one embodiment, a weight factor scale between 0-10 is used to indicate a level of importance for each selection factor, and the coefficients 1.0, 0.5, and 0.1 are used to represent the H/M/L ranking criteria. The rank “F” is used to screen out candidate products and thereby to reduce number of candidates—the TMI scoring logic will set the TMI score to zero if any factor is ranked “F”. The conversion from qualitative data to numerical data in this embodiment is done based on an expert's “intuition.” Such intuitive conversion, however, lacks of rigor and often requires manual adjustments based on validation and existing cases. That is, the adjustments on weight factors and ranking criteria are done iteratively until the TMI scores “look and feel” appropriate.

In a preferred embodiment, the manual adjustment process is modeled as a constrained non-linear optimization problem, enabling the adjustments on the weight factors and ranking criteria to be automated. In this manner, the qualitative information such as “selection factor A is more important than selection factor B” can be quantified in an analytical fashion.

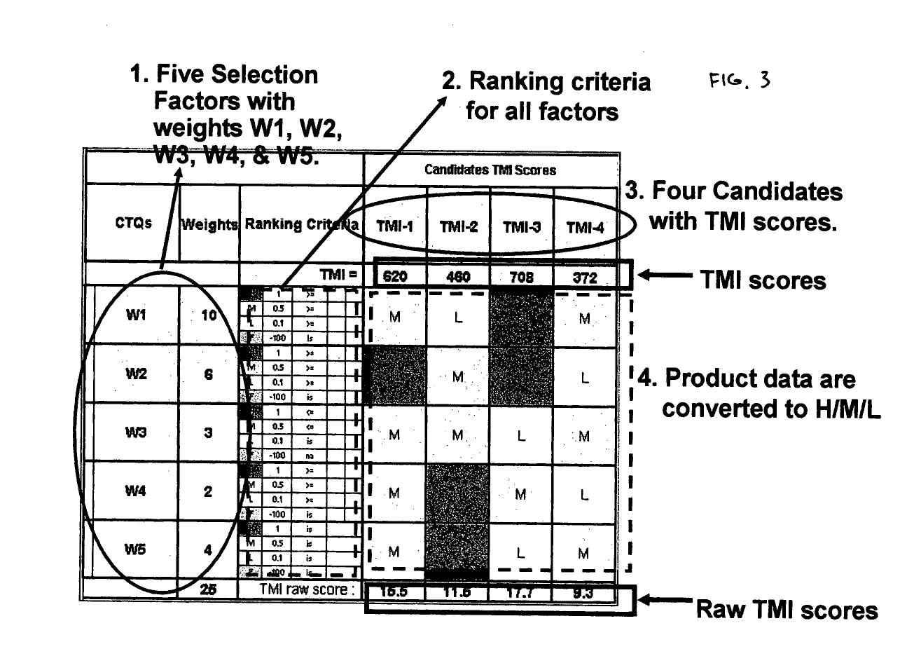

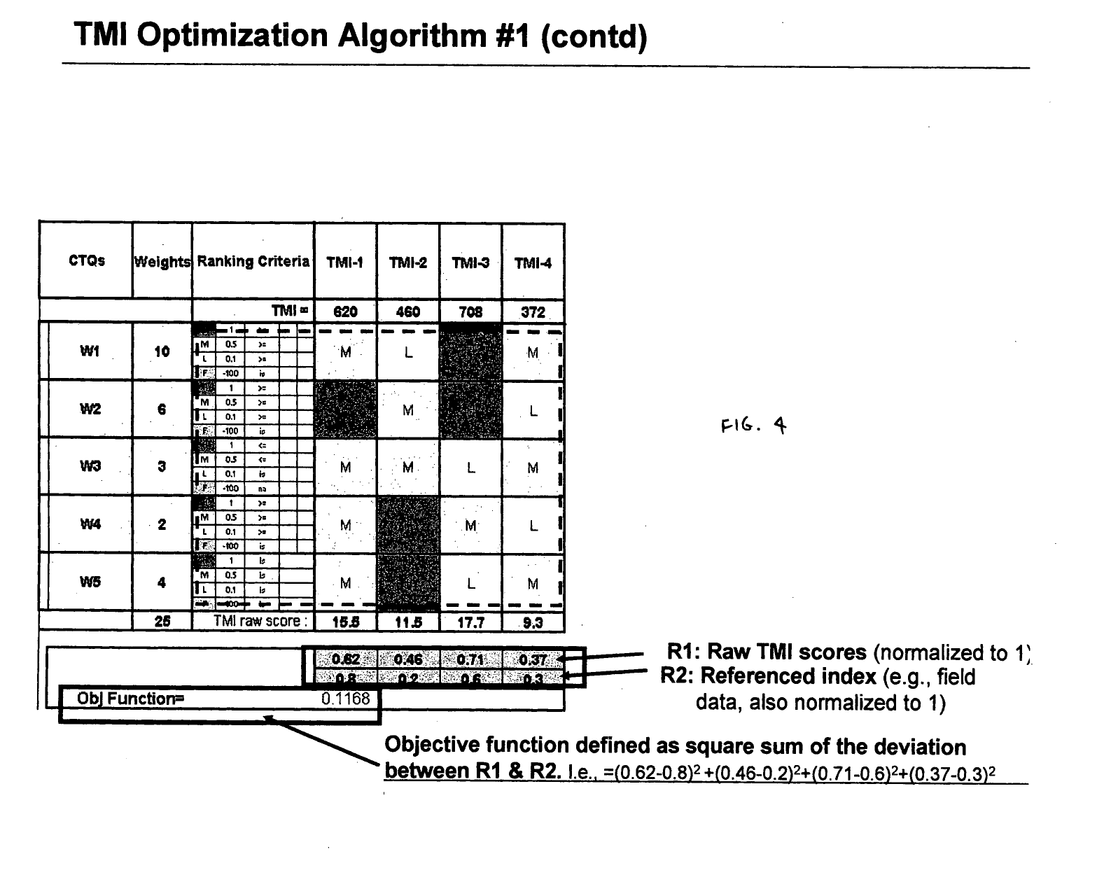

With reference to FIG. 3, if the user changes data relating to weight factors 18, ranking criteria 20 or product specifications 14, the TMI scores are recomputed accordingly. Suppose the engineer is unsure about the weight factors, specifically for W2, W3 and W4, and would like to use the field data available (e.g., actual failure information for the candidate product) to evaluate these weights. With reference to FIG. 4, this task can be accomplished by setting up an optimization model in the spreadsheet application as follows:
(a) define row R1 as normalized raw score; in this example, it shows 0.62, 0.46, 0.71 and 0.37 for the four candidates.
(b) define row R2 as reference index based on field data; in this example, it shows 0.8, 0.2, 0.6, and 0.3, which represent estimated actual performance for the candidates (the higher the better).
(c) define the objective function as a summation of the square of deviation between cells of R1 and R2. E.g., obj=(0.62−0.8)²+(0.46−0.2)²+(0.71−0.6)²+(0.37−0.3)²)=0.1168; and
(d) set the optimization variables as W2, W3 and W4 in order to minimize the objective function. The objective function is defined with the intention to bring the TMI scores as close as possible to the reference index by varying the specified weights using an optimization driver. That is, using the optimization driver, a set of weights such as W2, W3 and W4, can be adjusted automatically so that the scores are “closer” to desired magnitudes.

The theoretical minimum of the so-defined objective function is zero, in which case, the weight factors would reach exactly the reference index. However, it is important to recognize that the objective function could be a multi-valley function, in which case the local minimums are non-zero. The non-zero local minimum in such case represents a possible set of weight factors that can lead to TMI scores which are closer to the specified referenced index than initial weights. During running minimization, the resultant weights can be adjusted automatically to be closer to the specified reference index, to a certain degree. Note that the human experts are encouraged to input his/her domain knowledge into the optimization model, such as specifying specific bounds of weights or indicating the relationship among weights. For example, if the user thinks W2 should be of medium weight with W3 and W4 of lesser weight, the user may set W2 between [4, 8] and W3 and W4 as between [1, 5]. Further, the user may add in W3>W4 as a constraint if the user thinks W3 is more important than W4. These additional constraints help to ensure that results meet user expectations.

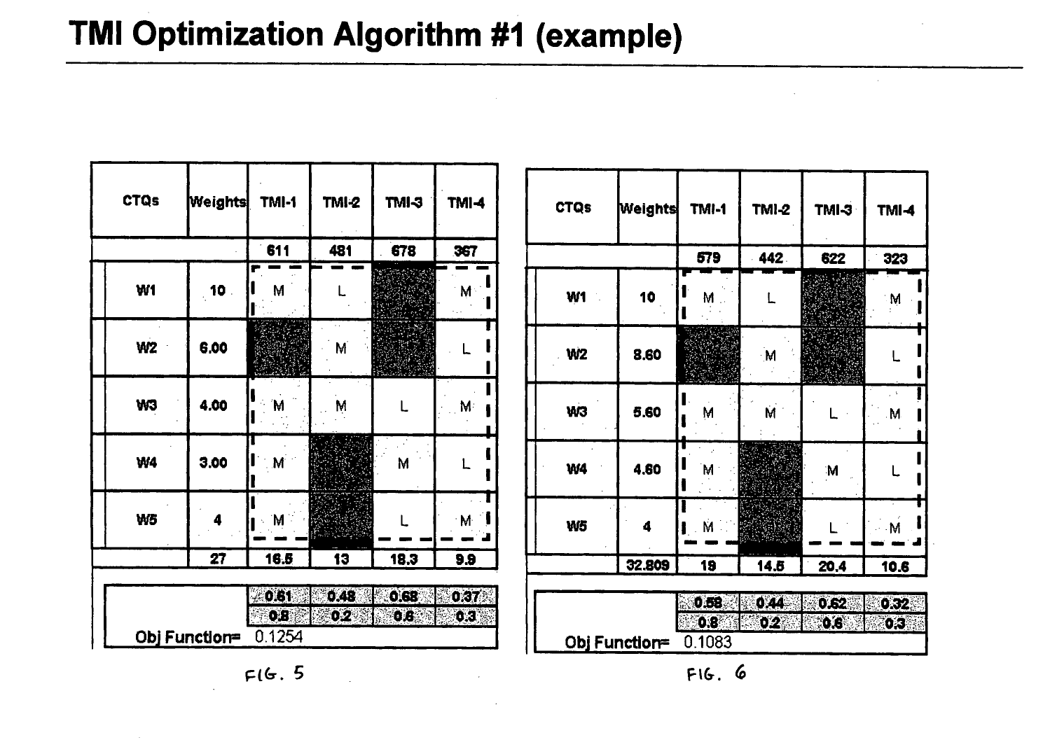

A sample case is illustrated in FIGS. 5 and 6. FIG. 5 shows the initial weights as 6, 4, and 3 for W2, W3 and W4, respectively. One minimization run yielded weights as 8.6, 5.6, and 4.6, with the objective function value being 0.1083, which is reduced from the initial 0.1254. This example demonstrates that the optimization model can automatically adjust the weights to a certain degree in order to approach the referenced scores.

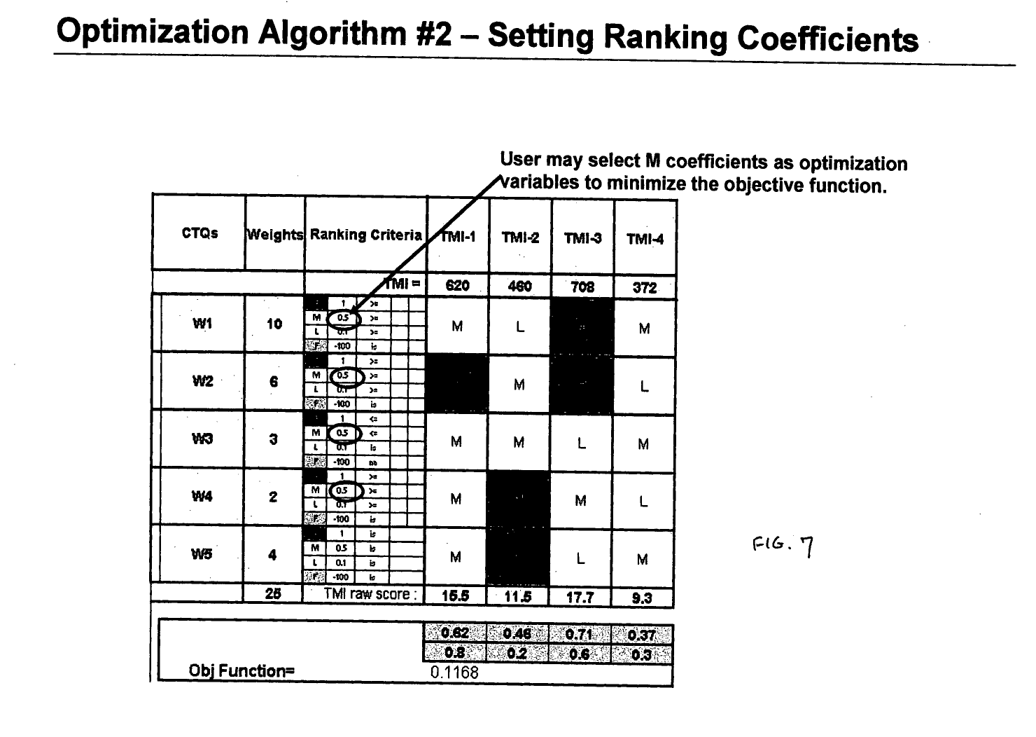

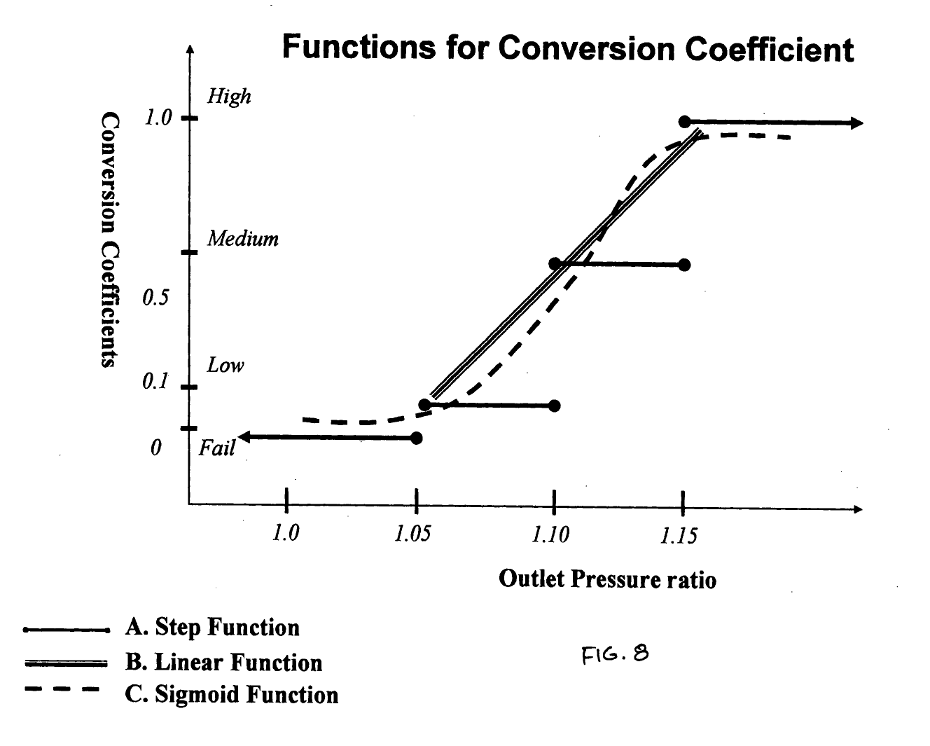

In addition, the ranking criteria could be extended to a continuous function instead of using the simple step function (1.0/0.5/0.1), which could be more suitable when the ranking criteria is in a continuous range of number. FIG. 8 illustrates the options in choosing the conversion function: A. Step Function, B. Linear function, and C. Sigmoid function. Regardless which function is used, the common question is how to quantitatively determine the function parameters—such as the “M” value for the step function, or the slope for the linear and sigmoid function. With the optimization model described above, these function parameters can be determined by minimizing the same objective function. With reference to FIG. 7, the objective function remains the same, but design variables can add in M-coefficients (default is 0.5) with H and L fixed at 1.0 and 0.1, and varying M in the range of (0.1, 1.0). Such optimization model provides an analytical basis for setting the conversion function (i.e., the H, M and L coefficients for using a step function)

The two optimization algorithms presented here do not intend to replace the manual setting by domain experts. Instead, the algorithms can assist the expert to set those numbers with uncertainty provided certain reference information are available (e.g., the field data, or past records).

Implementation of the optimization models can be accomplished in Excel/Solver or any specialized software tool such as iSIGHT™ or ModelCenter™. To eliminate the knowledge hurdle of the specialty tool, a simplified and error-proof GUI can be implemented to fully utilize the power of optimization models.

From a technical standpoint in the development phase, the TMI tool is developed using a known spreadsheet product (step S13) and the tool can be customized to different applications (step S14).

With the TMI tool and method, the selection of candidate products can be facilitated based on a more objective analysis then previously accomplished. The use of optimization algorithms is particularly beneficial if the TMI tool needs to process a large number of candidate products such as in a web environment (as disclosed in the related application noted above). The algorithms may also be applied to investigate potential correlations between selection factors and product information like price or field reliability data and the like.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of quantifying product technical merit to facilitate product selection, the method comprising:
(a) identifying selection factors for a product to be selected;
(b) establishing a weight factor relating to an importance level for each of the identified selection factors using a first nonlinear optimization algorithm;
(c) defining ranking criteria for each of the identified selection factors including at least two levels as high (H) and low (L) using a second nonlinear optimization algorithm;
(d) determining a technical merit index for each candidate product based on a summation of normalized product specifications for each of the identified selection factors weighted by the respective weight factor and multiplied by the respective ranking criteria; and
(e) selecting one of the candidate products based at least partly on a comparison the technical merit index of each candidate product.

2. A method according to claim 1, wherein the first optimization algorithm is established based on minimizing an objective function according to a deviation from referenced scores.

3. A method according to claim 2, wherein the second optimization algorithm defines an analytical mean to set a ranking criteria conversion function using the objective function.

4. A method according to claim 1, wherein step (b) is practiced by (i) defining row R1 as a row of normalized raw scores for each candidate product; (ii) defining row R2 as a row of reference indices based on field data for each candidate product; (iii) defining an objective function as a summation of the square of deviation between cells of R1 and R2; and (iv) setting the weight factors in order to minimize the objective function.

5. A method according to claim 1, wherein the first and second nonlinear optimization algorithms determine optimized weight factors and ranking criteria by determining an objective function as a summation of the square of deviation between normalized scores for each candidate product and reference indices based on field data for each candidate product, and setting the weight factors and ranking criteria in order to minimize the objective function.

6. A technical merit index tool for establishing qualification thresholds to facilitate product selection, the technical merit index tool comprising:
a technical user input section including defined selection factors and desired values for each of the selection factors for a product to be selected, the desired values including a weight factor relating to an importance level for each of the defined selection factors using a first nonlinear optimization algorithm and ranking criteria for each of the defined selection factors using a second nonlinear optimization algorithm;
a product supplier input section including product specifications relating to the defined selection factors; and
a processor that determines a technical merit index for each candidate product based on a summation of normalized product specifications for each of the defined selection factors relative to the desired values.

7. A technical merit index tool according to claim 6, wherein the first nonlinear optimization algorithm is defined based on a qualitative comparison of respective selection factors.

8. A technical merit index tool according to claim 7, wherein the second nonlinear optimization algorithm defines the ranking criteria as a nonlinear continuous function based on the relative weight factors of the respective selection factors.

9. A technical merit index tool according to claim 6, wherein the first nonlinear optimization algorithm is configured by (i) defining row R1 as a row of normalized raw scores for each candidate product; (ii) defining row R2 as a row of reference indices based on field data for each candidate product; (iii) defining an objective function as a summation of the square of deviation between cells of R1 and R2; and (iv) choosing any weight factors or ranking conversion factors as optimization variables to be automatically adjusted by an optimization driver.
